(19) United States
(12) Patent Application Publication
(10) Pub. No.: US 2014/0355778 A1
(43) Pub. Date: Dec. 4, 2014

(54) HEADPHONE DEVICE AND CONTROL METHOD THEREOF

(71) Applicant: DEXIN CORPORATION, New Taipei City (TW)

(72) Inventor: WANG-DONG CHENG, New Taipei City (TW)

(21) Appl. No.: 13/908,252

(22) Filed: Jun. 3, 2013

(51) Int. Cl. H04R 1/10

(52) U.S. Cl. CPC H04R 1/1041
USPC 381/74

(57) ABSTRACT

A headphone device comprises a first audio input interface, a second audio input interface, a speaker unit and a control unit. The control unit is coupled to the first audio input interface, the second audio input interface and the speaker unit. The control unit determines whether an audio signal is inputted by the first audio input interface or the second audio input interface, and then controls the playing mode of the speaker unit to play the audio signal in a first mode or in a second mode based on decision result.

### BACKGROUND OF THE INVENTION

1. Field of the Invention

The present invention relates to a headphone device and a control method thereof; in particular, to a headphone device, suitable to be worn by a user, and a control method thereof.

2. Description of Related Art

A headphone device is a miniature sound output device and is one of necessary fittings in a portable multi-medium apparatus. Under condition that a user does not disturbs others, the user uses a headphone device coupled to a multi-medium apparatus such as MP3, iPod, portable listening device, radio set, miniature audio set, such that audio signals can be outputted from a speaker unit of the headphone device. Thus, a user can perform an amusement action such as listening to music, watching a moving picture or operating an electronic game etc.

### SUMMARY OF THE INVENTION

The object of the present invention is to provide a headphone device and a control method thereof, such that a user can control more conveniently a using mode when the headphone device plays an audio signal.

The present invention provides a headphone device, which comprises a first audio input interface, a second audio input interface, a speaker unit and a control unit. The control unit is coupled to the first audio input interface, the second audio input interface and the speaker unit. The control unit determines whether an audio signal is inputted by the first audio input interface or the second audio input interface, and then controls the playing mode of the speaker unit to play the audio signal in a first mode or in a second mode based on decision result.

In an embodiment of the present invention, when the control unit determines that the first audio input interface has received the audio signal, the speaker unit is controlled to play the audio signal in a first mode, and when the control unit determines that the second audio input interface has received the audio signal, the speaker unit is controlled to play the audio signal in a second mode.

The present invention provides a control method of a headphone device, and the headphone device comprises a first audio input interface, a second audio input interface, a speaker unit and a control unit. The control method comprises: determining whether an audio signal is inputted by the first audio input interface or the second audio input interface; and then controlling the playing mode of the speaker unit to play the audio signal in a first mode or in a second mode based on decision result.

The control unit of the present invention is used to determine whether the first audio input interface or the second audio input interface receives an audio signal, so that a user only needs to control the audio signal to let the audio signal be inputted into the first audio input interface and the second audio input interface, then the speaker unit can be controlled to play the audio signal in a first mode or in a second mode, so as to enhance the using convenience of the headphone device.

In order to further the understanding regarding the present invention, the following embodiments are provided along with illustrations to facilitate the disclosure of the present invention. However, the description and drawings are merely provided for reference and illustration, without any intention to be used for limiting the present invention.

### BRIEF DESCRIPTION OF THE DRAWINGS

FIG. 1 shows a functional diagram of a headphone device according to an embodiment of the present invention;

FIG. 2 shows an operation schematic diagram of a headphone device according to the embodiment of FIG. 1 in the present invention;

FIG. 3 shows a stereoscopic schematic diagram of a headphone device according to another embodiment of the present invention;

FIG. 4 shows an operation schematic diagram of a headphone device according to another embodiment of the present invention;

FIG. 5 shows a flow chart of the control method for controlling a headphone device according to another embodiment of FIG. 2 in the present invention;

FIG. 6 shows a flow chart of the control method for controlling a headphone device according to another embodiment of FIG. 4 in the present invention; and

FIG. 7 shows a flow chart of the control method for controlling a headphone device according to another embodiment of FIG. 4 in the present invention.

### DETAILED DESCRIPTION OF THE PREFERRED EMBODIMENTS

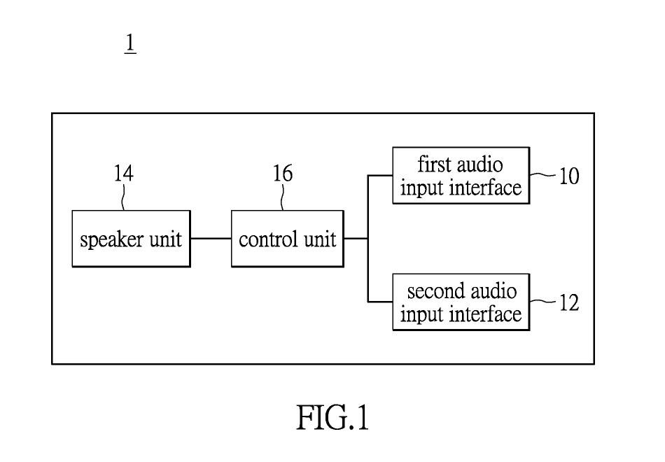

FIG. 1 shows a functional diagram of a headphone device according to an embodiment of the present invention. Please refer to FIG. 1. A headphone device 1 comprises a first audio input interface 10, a second audio input interface 12, a speaker unit 14 and a control unit 16. In practice, the control unit 16 is coupled among the speaker unit 14, the first and the second audio input interfaces 10, 12, so that the headphone device 1 can control the playing mode of the speaker unit 14 to play the audio signal in a first mode or in a second mode via the first audio input interface 10 or the second audio input interface 12.

Please refer to FIG. 1 continuously. The speaker unit 14 is coupled to the control unit 16 that outputs an audio signal. In practice, the speaker unit 14 may be, for example, a horn, which may be driven by power to produce sound. The type of the speaker unit 14 is not limited in the present embodiment.

The first audio input interface 10 is an insertion slot coincident with a universal serial transmission protocol. In practice, the first audio input interface 10 is, for example, a universal serial bus (USB), a Mini USB, a Micro USB, or other insertion slots or plugs suitable for simultaneously transmitting signal and current. The type of the first audio input interface 10 is not limited in the present embodiment.

The second audio input interface 12 is an audio jack. In practice, the second audio input interface 12 may be, for example, an insertion hole or a plug of a general standard audio set 3.5 mm JACK, an insertion hole or a plug of a general standard audio set 6.5 mm JACK, or an audio insertion hole or a plug of other specification. The type of the second audio input interface 12 is not limited in the present embodiment. In addition, the first audio input interface 10 is different from the second audio input interface 12, and the headphone device 1 of the present invention can provide two categories of audio input interface. The two categories of audio input interface are connected to a multi-medium apparatus via plugs of different specifications, so as to receive audio signals. Thus, a user may hear a sound effect of the first mode via the first audio input interface 10, or the user may hear a sound effect of the second mode via the second audio input interface 12.

The control unit 16 is coupled among the first audio input interface 10, the second audio input interface 12 and the speaker unit 14. The control unit 16 determines whether the first audio input interface 10 or the second audio input interface 12 inputs an audio signal, and according to the decision result controls the playing mode of the speaker unit 14 such that the audio signal is played in a first mode or a second mode. In practice, when the control unit 16 determines that the first audio input interface 10 receives an audio signal, the speaker unit 14 is controlled to play the audio signal in a first mode, and when the control unit 16 determines that the second audio input interface 12 receives an audio signal, the speaker unit 14 is controlled to play the audio signal in a second mode, wherein the first mode is a game mode and the second mode is a music mode.

To describe in detail, the control unit 16 is a CPU or a micro-processor (MCU) etc., used for performing signal computation and processing among each unit and interface of the headphone device 1. When the first or the second audio input interface 10, 12 receives an audio signal, a trigger signal will be generated to the control unit 16. For example, when the first audio input interface 10 receives an audio signal based on electrically connected to transmission lines of USB and generates a trigger signal, the control unit 16 will control according to the trigger signal the speaker unit 14 to output an audio signal in a first mode.

For example, an electronic game is a First Person Shooting, a Role Playing Game or a Real Time Strategy etc. When a user performs an electronic game, the user may let the first audio input interface 10 be coupled to a computer apparatus, so that the computer apparatus outputs an audio signal to the first audio input interface 10, thus the control unit 16 can control the speaker unit 14 to play the audio signal in a game mode, wherein the game mode means, for example, that the audio signal is outputted by an equalizer or an average audio, thereby the bass tone will not be over-weighted or the amount of the bass tone will not have too much reverberation, thus the blasting sound in a game cannot cover a gun sound or a foot stepping sound, and a user may clearly hear the sound in a detailed portion of a game. Therefore, a user can easily identify an enemy's position by hearing the sound, so as to highly grasp the enemy's tendency. The type of a game mode is not limited in the present embodiment.

Music may be, for example, a popular music, a station music or a classical music etc. When a user hears a music, the user may let the second audio input interface 12 be coupled to a computer apparatus, so that the computer apparatus outputs an audio signal to the second audio input interface 12. Thus, the control unit 16 can control the speaker unit 14 to play the audio signal in a music mode, wherein the music mode means that the audio signal is outputted in an audio of treble, bass, heavy bass, surround sound or stereo sound, thereby said treble, bass, heavy bass, surround sound or stereo sound in a music can be clearly outputted to a user. Therefore, the user can enjoy the fun of hearing the music. The type of a music mode is not limited in the present embodiment.

It is worth mentioning that a default value is set in the control unit 16. When the first and the second audio input interfaces 10, 12 are plugged at the same time and an audio signal is inputted, the default value indicates that one of the first and the second audio input interfaces 10, 12 is operated. Thus, the control unit 16 preferably controls according to the default value the speaker unit 14 to play the audio signal in a first or a second mode. The type of the default value is not limited in the present embodiment.

In other embodiments, the headphone device 1 may have three, four or more audio input interfaces, wherein the third audio input interface (not shown) may be identical to the first or the second audio input interface 10, 12. For example, the third audio input interface is an insertion slot compatible with a universal serial transmission protocol, wherein the third audio input interface is identical to the first audio input interface 10. When the control unit 16 determines that the third audio input interface receives an audio signal, the speaker unit 14 is controlled to play the audio signal in a third mode, wherein the third mode is a moving picture mode, a lecture mode or a theater mode, thereby a user may watch the moving picture, the theater or hear a lecture or a conversation of a well-known person. The types of the first, the second and the third audio input interfaces are not limited in the present embodiment.

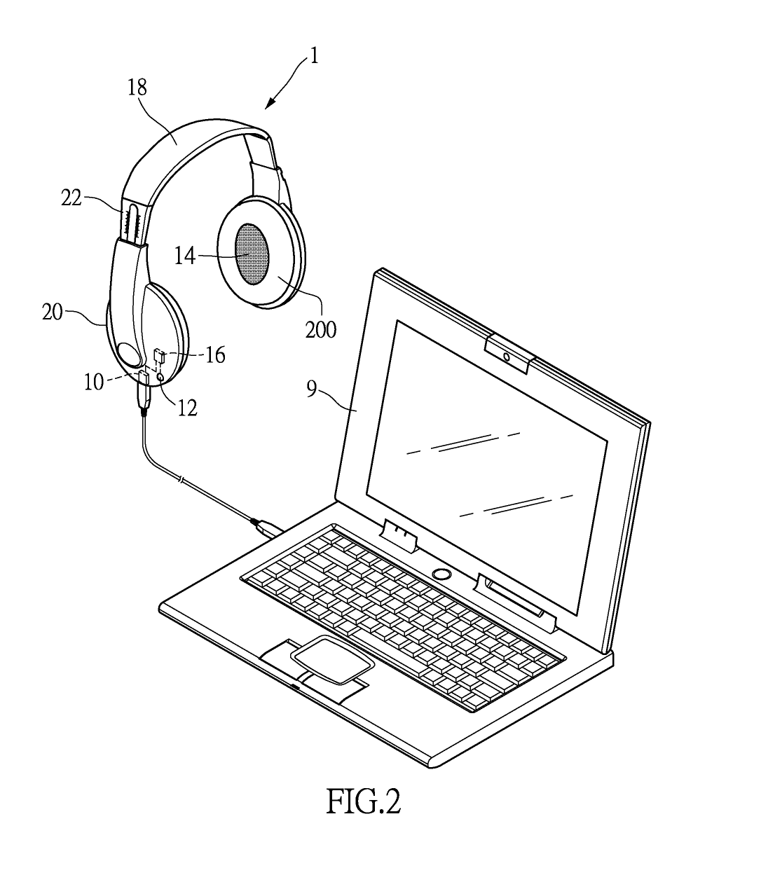

FIG. 2 shows an operation schematic diagram of a headphone device according to the embodiment of FIG. 1 in the present invention. Please refer to FIG. 2. The headphone device 1 of the present embodiment is illustrated with a head-wearing headphone. In other embodiments, the headphone device 1 may be, for example, a headset (an earphone with a microphone) or a convenient headphone whose skeleton is foldable. The type of the headphone device 1 is not limited in the present embodiment. In the head-wearing headphone of the present embodiment, the control unit 16 determines whether the first or the second audio input interface 10, 12 receives an audio signal, and controls the speaker unit 14 to play the audio signal in a first or a second mode. In the following, same elements are represented with same symbols. The type of the headphone device 1 is not limited in the present embodiment.

The headphone device 1 shown in FIG. 2 is connected to a host 9. The host 9 may be, for example, a computer host, a notebook or a tablet computer, a mobile communication device or a Personal Digital Assistant (PDA). The host 9 in the present embodiment is illustrated with a notebook. The type of the host 9 is not limited in the present embodiment.

The headphone device 1 further comprises a hang-arm 18, an earmuffs portion 20 and a regulation portion 22. In practice, the control unit 16, the speaker unit 14, the first and the second audio input interfaces 10, 12 are disposed in the headphone device 1. For example, the control unit 16 and the speaker unit 14 are disposed in the earmuffs portion 20, whereas the first and the second audio input interfaces 10, 12 are exposed on the outer surface of the earmuffs portion 20, wherein the first audio input interface 10 is, for example, an insertion slot compatible with a universal serial transmission protocol, the second audio input interface 12 is, for example, a socket of a general standard audio set 3.5 mm JACK. The type shown in FIG. 2 is not limited in the present embodiment.

The hang-arm 18 is, for example, a rod body made of either metal having elasticity or plastic material, wherein the hang-arm 18 may be designed according to the head shape of the user. Those skilled in the art may perform a free design according to requirement. In addition, the hang-arm 18 may have a leather sponge, woody sponge or other elastic pad body, so as to enhance the comfortability of a user during a long time wearing period. The type of the hang-arm 18 is not limited in the present embodiment.

The regulation portion 22 is pivoted between the hang-arm 18 and the earmuffs portion 20, and the regulation portion 22 is used to regulate the distance between the hang-arm 18 and the earmuffs portion 20. In practice, the two ends of the hang-arm 18 are respectively connected with the regulation portion 22. The regulation portion 22 has a retractable structure that can be regulated to be suitable for different sizes of head shape, thus a user may let the earmuffs portion 20 be roughly located beside the ear canal of a user's outer ear by means of the regulation portion 22, wherein the regulation portion 22 may be a retractable structure that can be manually regulated or automatically regulated. The type of the regulation portion 22 is not limited in the present embodiment.

Please refer to FIG. 2. The earmuffs portion 20 is connected with the regulation portion 22. In practice, the earmuffs portion 20 has functions of sound separation and ear covering. The earmuffs portion 20 has cushions 200 closely laminated at the periphery of pinna. In the cushions 200, generally a sound-absorbing material is lined, so as to prevent the outside sound from transferring to the ear of a user. The speaker unit 14 is accommodated in the earmuffs portion 20, such that the speaker unit 14 is roughly located beside the ear canal of a user's outer ear, so as to output an audio signal to a user. The earmuffs portion 20 may be, for example, a circular body or an ellipsoid body made of metal, plastic or woody material. The type of the earmuffs portion 20 is not limited in the present embodiment. In addition to the above difference, those skilled in the art should easily infer other differences by referring to the above embodiments and difference, therefore the description thereof is omitted here.

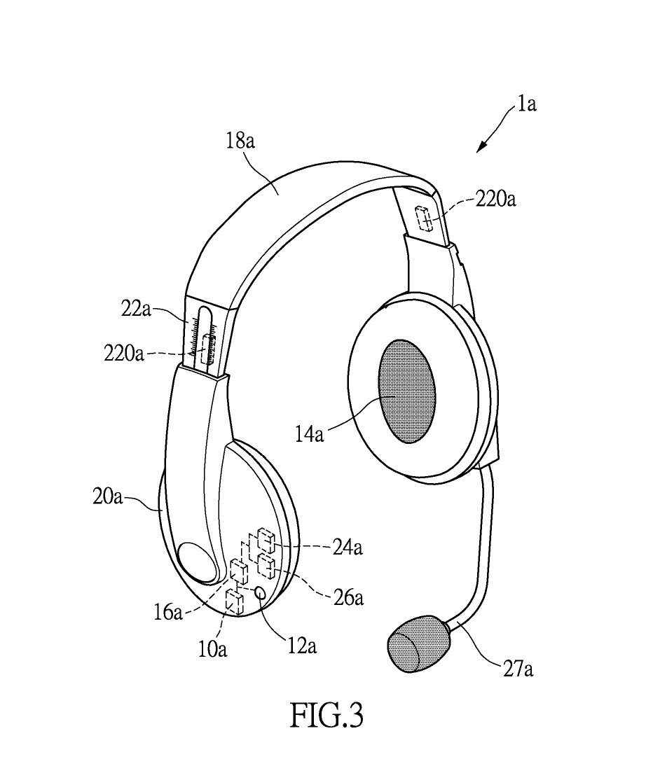

FIG. 3 shows a stereoscopic schematic diagram of a headphone device according to another embodiment of the present invention. Please refer to FIG. 3. The headphone device 1a of the present embodiment is similar to the headphone device 1 of the previous embodiment. For example, in the headphone device 1a the control unit 16a determines whether the first and the second audio input interfaces 10a, 12a receive an audio signal, so as to control the speaker unit 14a to play an audio signal in a game mode or in a music mode. However, the difference between the headphone device 1a, 1 still exists and consists in that the headphone device 1a of the present embodiment is, for example, a headset, wherein a microphone 27a is connected to one of two earmuffs portions 20a and is used for receiving external audio signal, for example, a user's sound. The type of the headphone device 1a is not limited in the present embodiment.

Next, the regulation portion 22a has a variable resistance unit 220a, and the variable resistance unit 220a is electrically connected to a control unit 16a, wherein the variable resistance unit 220a outputs relatively a resistance value to serve as a position signal according to the distance between the earmuffs portions 20a and the hang-arm 18s. By way of example, when the retractable structure of the regulation portion 22a presents a longer length, the variable resistance unit 220a may output a larger resistance value. On the contrary, when the retractable structure of the regulation portion 22a presents a shorter length, the variable resistance unit 220a may output a smaller resistance value. Thus, the resistance value may be used as a position signal of the regulation portion 22a when a user wears the headphone device 1a.

If a first person has a longer head shape, for example, when the surface scale of the regulation portion 22a shows 20 cm, the variable resistance unit 220a outputs a resistance value of about 10 ohms. If a second person has a shorter head shape, for example, when the surface scale of the regulation portion 22a shows 10 cm, the variable resistance unit 220a outputs a resistance value of about 5 ohms. Thus, the control unit 16a records the position signal of the regulation portion 22a according to the size of resistance value when the first person or the second person wears the headphone device 1a, wherein the control unit 16b has, for example, a storage element (not shown). The storage element is used for storing the position signal of the regulation portion 22a when the first person or the second person wears the headphone device 1a. The type of the control unit 16b is not limited in the present embodiment.

In other embodiments, when the retractable structure of the regulation portion 22a presents a shorter length, the variable resistance unit 220a may output a larger resistance value. On the contrary, when the retractable structure of the regulation portion 22a presents a longer length, the variable resistance unit 220a may output a smaller resistance value. The relative operation status between the regulation portion 22a and the variable resistance unit 220a is not limited in the present embodiment.

In addition, the headphone device 1a of the present embodiment further comprises a setting interface 24a and a playing interface 26a. In practice, the setting interface 24a is coupled to a control unit 16a and generates a setting signal to the control unit 16a, such that the control unit 16a can control the variable resistance unit 220a to record a position signal according to the setting signal.

By way of example, the setting interface 24a has setting keys A and B (not shown). When the first person wears the headphone device 1a at first time, the first person regulates a most suitable position for wearing by means of the regulation portion 22a. Next, the first person presses, for example, the setting key A, so as to record the position signal of the regulation portion 22a when the first person wears the headphone device 1a. Therefore, when the first person wears again the headphone device 1a, the first person presses again the setting key A, the regulation portion 22a of the headphone device 1a can be automatically regulated to a position at which the surface scale presents 20 cm. As can be known similarly, the setting keys A and B can record respectively the position signal of the regulation portion 22a when the first person and the second person wear the headphone device 1a. In other embodiments, the setting interface 24a may have three, four or several setting keys. The type of the setting interface 24a is not limited in the present embodiment.

It is worth mentioning that the setting interface 24a has keys or knobs (not shown) too, wherein the keys or knobs are used to regulate the sound range regulation parameter and/or sound volume regulation parameter when the speaker unit 14a outputs sound. Therefore, a user may set a game mode or a music mode according to preference when the user personally operates an electronic game or hears music. Of course, the setting keys can record the sound range regulation parameter and/or sound volume regulation parameter when the speaker unit 14a outputs sound. For example, when the first person operates an electronic game, the first person will set the sound volume regulation parameter to be 60 dB when the speaker unit 14a outputs sound. The first person uses a setting key to record both the position signal of the regulation portion 22a when the first person wears the headphone device 1a and a sound volume regulation parameter of 60 dB. When the first person wears again the headphone device 1a and presses again the setting key A, the regulation portion 22a of the headphone device 1a can be regulated automatically to a position at which the surface scale shows 20 cm, and the sound volume regulation parameter is set to be a status of 60 dB when the speaker unit 14a outputs sound. The type of the setting interface 24a is not limited in the present embodiment.

In addition, the playing interface 26a is coupled to the control unit 16a and generates a playing instruction according to a user's operation, such that the control unit 16a can control the playing mode of the speaker unit 14a according to the playing instruction. In practice, the playing interface 26a may be realized by keys or knobs (not shown). For example, the headphone device 1a controls via the playing interface 26a the playing mode of the speaker unit 14a to play an audio signal in a game mode or in a music mode. The type of the playing interface 26a is not limited in the present embodiment. In addition to the above difference, those skilled in the art should easily infer other differences by referring to the above embodiments and difference, therefore the description thereof is omitted here.

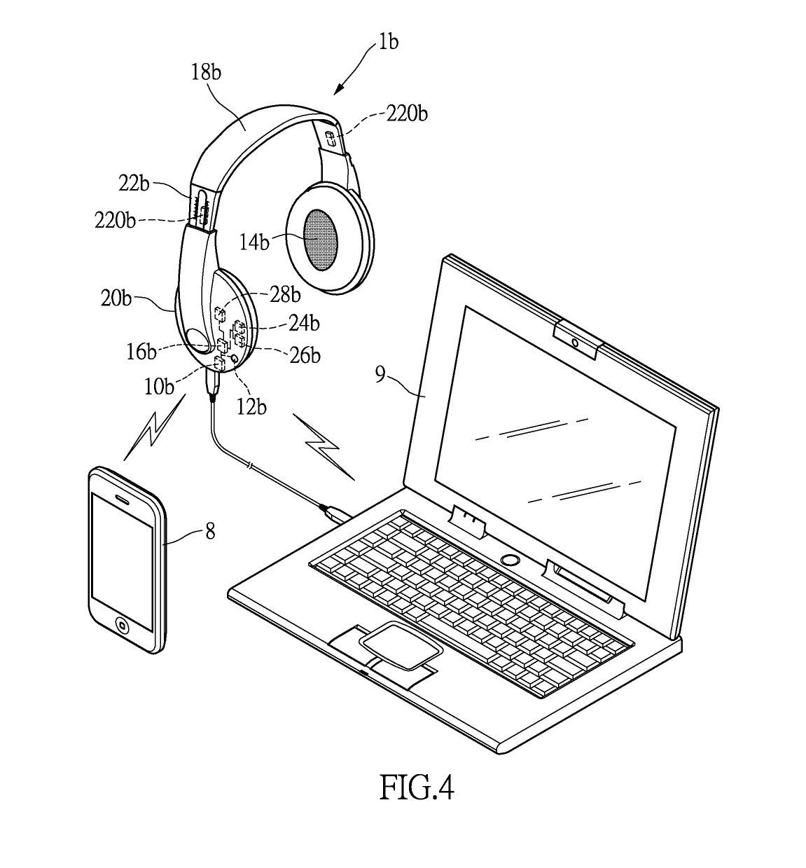

FIG. 4 shows an operation schematic diagram of a headphone device according to another embodiment of the present invention. Please refer to FIG. 4. The headphone device 1b of the present embodiment is similar to the headphone device 1 of the previous embodiment. However, the difference between the headphone device 1b, 1 still exists and consists in that the headphone device 1b of the present embodiment further comprises a wireless communication unit 28b coupled to the control unit 16b, wherein the control unit 16b outputs via the wireless communication unit 28b a position signal to a host 9, such that an application program of the host 9 recognizes the position signal and outputs relatively a first regulation signal to the headphone device 1b. When the control unit 16b receives the first regulation signal via the wireless communication unit 28b, the playing mode of the speaker unit 14b is regulated according to the first regulation signal, wherein the first regulation signal regulates sound range regulation parameter and/or sound volume regulation parameter when the speaker unit 14b outputs sound.

Moreover, the wireless communication unit 28b is, for example, a Bluetooth communication transceiver, a Wireless LAN communication RF transceiver, a Wireless PAN communication RF transceiver, a Wi-Fi communication RF transceiver, an IEEE 802.11 communication RF transceiver or a ZigBee communication RF transceiver, thus a signal can be wirelessly transmitted between the wireless communication unit 28b and the host 9.

The headphone device 1b has a setting interface 24b, a playing interface 26b and a wireless communication unit 28b, wherein a user triggers the setting interface 24b so as to generate a setting signal to the control unit 16b, such that the control unit 16 can control according to the setting signal the variable resistance unit 220b to record a position signal, wherein the position signal is transmitted to the host 9 via the control unit 16b and the wireless communication unit 28b, such that the application program of the host 9 can recognize the position signal and outputs relatively a first regulation signal to the headphone device 1b. The operation type of the headphone device 1b and the host 9 is not limited in the present embodiment.

In other embodiments, the headphone device 1b has, for example, the wireless communication unit 28b, whereas the headphone device 1b doesn't have the setting interface 24b and the playing interface 26b. In practice, when a user lets the host 9 and the first audio input interface 10b be coupled by means of USB transmission lines, the control unit 16b receives an audio signal via the first audio input interface 10b to generate a trigger signal, so as to control the speaker unit 14b to play the audio signal in a game mode, wherein the regulation portion 22b will output relatively according to the trigger signal a resistance value to the control unit 16b as a position signal, wherein the position signal is transmitted to the host 9 via the control unit 16b and the wireless communication unit 28b. Therefore, the host 9 recognizes the user according to the position signal, and then the host 9 outputs relatively a first regulation signal to the headphone device 1b.

In addition, the control unit 16b may receive via the wireless communication unit 28b a second regulation signal outputted by a mobile communication device 8, and regulates the playing mode of the speaker unit 14b according to the second regulation signal, wherein the second regulation signal regulates the sound range regulation parameter and/or sound volume regulation parameter when the speaker unit 14b outputs sound. In practice, the mobile communication device 8 is, for example, a notebook, a tablet computer, a smart handset or a Personal Digital Assistant (PDA). The type of the mobile communication device 8 is not limited in the present embodiment. For example, a user may control the playing mode of the speaker unit 14b by means of a smart handset, so as to output a rock music with heavy bass.

It is worth noting that the first and the second regulation signals are different from an audio signal, wherein the audio signal is transmitted to the control unit 16b via the first and the second audio input interface 10b, 12b, thereby the control unit 16b controls the speaker unit 14b to output the audio signal, while the regulation signal is transmitted to the control unit 16b via the wireless communication unit 28b, thereby the control unit 16b controls the sound volume or sound range of the audio signal outputted by the speaker unit 14b.

As can be known here, the audio signal is transmitted in wired mode to the headphone device 1b, while the regulation signal is transmitted in wireless mode to the headphone device 1b. Therefore, the audio signal and the regulation signal are independent and will not interfere with each other, wherein the audio signal is transmitted to the headphone device 1b without passing through the wireless communication unit 28b, thus the condition such as delay or noise, generated due to the fact that the audio signal is limited by a wireless communication bandwidth, is mitigated, while the regulation signal is transmitted to the headphone device 1b via the wireless communication unit 28b, thus the convenience of controlling the headphone device 1b is enhanced. In addition to the above difference, those skilled in the art should easily infer other differences by referring to the above embodiments and difference, therefore the description thereof is omitted here.

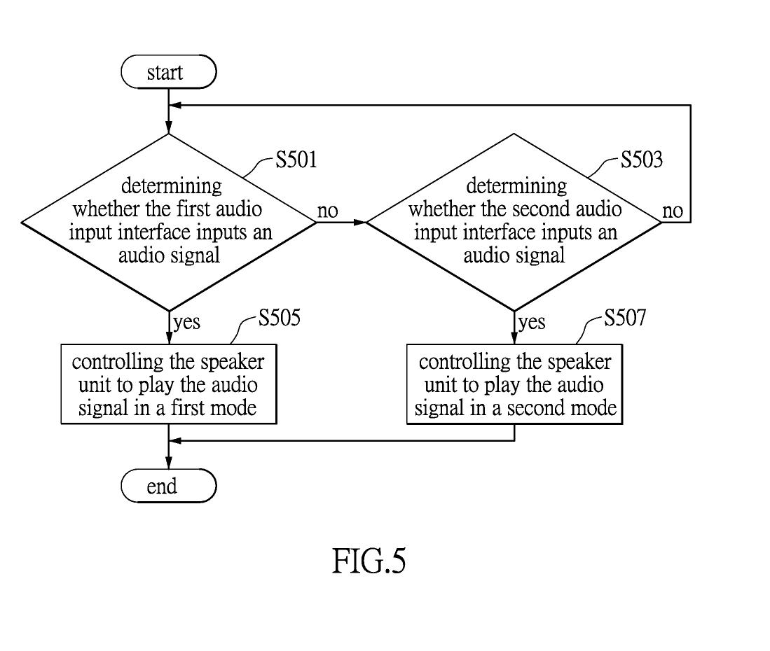

FIG. 5 shows a flow chart of the control method for controlling a headphone device according to another embodiment of FIG. 2 in the present invention. Please refer to FIG. 5 and FIG. 2. The headphone device 1 comprises a first audio input interface 10, a second audio input interface 12, a speaker unit 14 and a control unit 16. The method for controlling the headphone device 1 comprises:

In step S501, it is determined whether the first audio input interface 10 inputs an audio signal. If yes, step S505 is performed and the speaker unit 14 is controlled to play the audio signal in a first mode, wherein the first mode is a game mode. If no, step S503 is performed and it is determined whether the second audio input interface 12 inputs an audio signal.

If the decision in step S503 is yes, step S507 is performed and the speaker unit 14 is controlled to play the audio signal in a second mode, wherein the second mode is a music mode. If the decision in step S503 is no, then return to “start” of the present invention.

It is worth noting that, in the step of determined whether the first or the second audio input interface 10, 12 inputs an audio signal, firstly it may be determined whether the second audio input interface 12 inputs an audio signal, and then it is determined whether the first audio input interface 10 inputs an audio signal. The flow chart of steps S501 and S503 is not limited in the present embodiment.

In addition, a default value is set in the control unit 16. When the first and the second audio input interfaces 10, 12 are plugged at the same time and an audio signal is inputted, the default value indicates that one of the first and the second audio input interfaces is in operation, thus the control unit 16 preferably controls according to the default value the speaker unit 14 to play the audio signal in a first or a second mode. The type of the default value is not limited in the present embodiment.

In order to let those skilled in the art understand more clearly, a control method for controlling a headphone device according to another embodiment is provided.

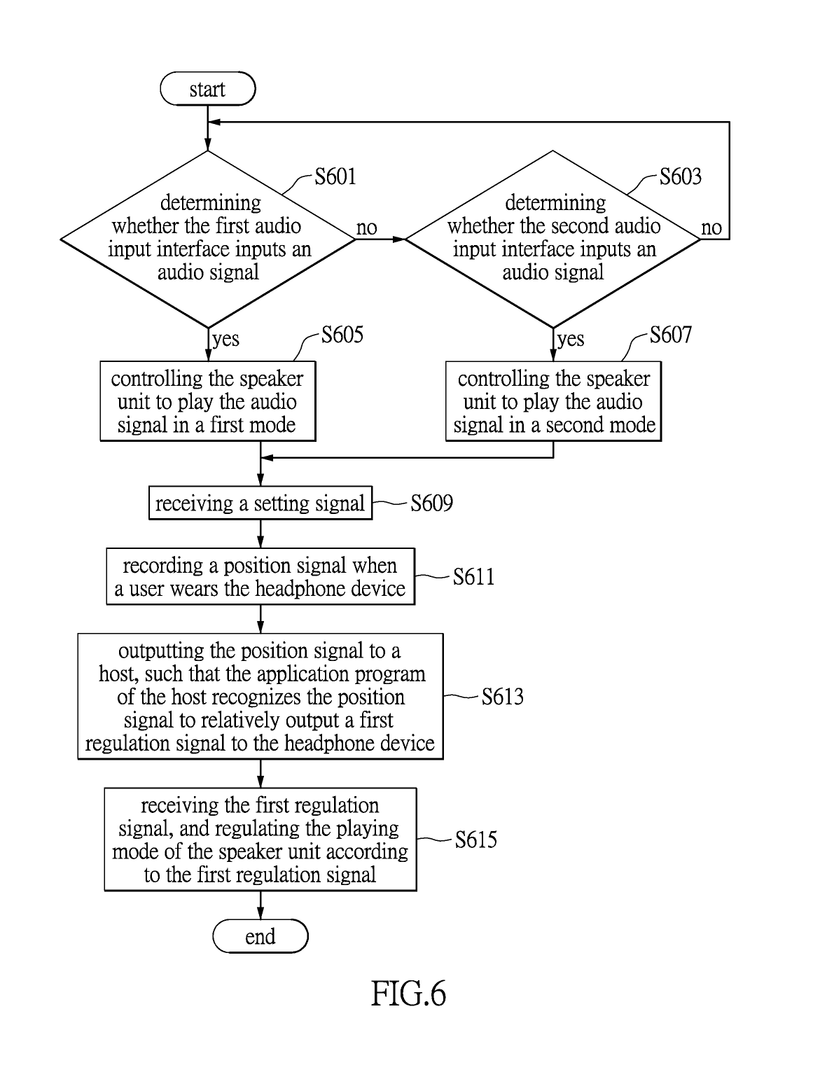

FIG. 6 shows a flow chart of the control method for controlling a headphone device according to another embodiment of FIG. 4 in the present invention. Please refer to FIG. 6 and FIG. 4. The control method for controlling a headphone device 1b of the present embodiment is similar to that for controlling a headphone device 1 of the previous embodiment. However, the difference of the control methods for controlling the headphone devices 1b, 1 consists in that in the present embodiment the headphone device 1b is controlled by a host 9, so as to control the sound volume and sound range outputted by the speaker unit 14b. In order to describe conveniently, the host 9 of the present embodiment is illustrated by a notebook.

To describe in detail, after step S605 or S607, step S609 is performed. In order to describe conveniently, in the present embodiment the step S605 is illustrated by “controlling the speaker unit 14b to play the audio signal in a first mode”.

Next, in step S609, a setting signal is received. In practice, a setting signal is received before a position signal of the headphone device 1b worn by a user is recorded. For example, the setting interface 24b has setting keys A, B, C (not shown). When a second user presses the setting key B, the setting interface 24b will generate a setting signal to the control unit 16b, such that the control unit 16b can control, according to the setting signal, a variable resistance unit 220b to record the position signal, thus a most suitable size for the second user to wear the headphone device 1b is recorded. Of course, a first user and a third user can press the corresponding setting key A or C, so as to record the most suitable size for the first or the third user to wear the headphone device 1b. The type of the setting interface 24b is not limited in the present embodiment. It is worth noting that step S609 may be replaced by “receiving a trigger signal”. For example, the first or the second audio input interface 10b, 12b receives an audio signal, thus the trigger signal is generated and transmitted to the control unit 16b, while the control unit 16b controls the variable resistance unit 220b to record the position signal. The flow chart of operation is similar to the content of the previous embodiment and will not be described here.

In step S613, the position signal is outputted to the host 9, so that the application program of the host 9 can recognize the position signal and output relatively a first regulation signal to the headphone device 1b. In practice, the application program of the host 9 can recognize the position signal of different resistance. For example, the application program of the host 9 can recognize that the position signals of 10 ohm and 5 ohm resistance values represent respectively a first user and a second user, thus the host 9 outputs relatively a first regulation signal to the headphone device 1. In step S615, the first regulation signal is received, and the playing mode of the speaker unit 14b is regulated according to the first regulation signal.

By way of example, the first user sets the sound volume outputted by the speaker unit 14b to be 60 dB so as to operate an electronic game, while the second user sets the sound volume outputted by the speaker unit 14b to be 80 dB so as to operate an electronic game. When the host 9 recognizes that the second user wears the headphone device, the host 9 transmits the first regulation signal to the control unit 16b, wherein the first regulation signal is the signal that sets the sound volume outputted by the speaker unit 14b to be 80 dB, thereby the speaker unit 14b outputs a sound volume of 80 dB to the second user. The type of the first regulation signal is not limited in the present embodiment. In addition to the above difference, those skilled in the art should easily infer other differences by referring to the above embodiments and difference, therefore the description thereof is omitted here.

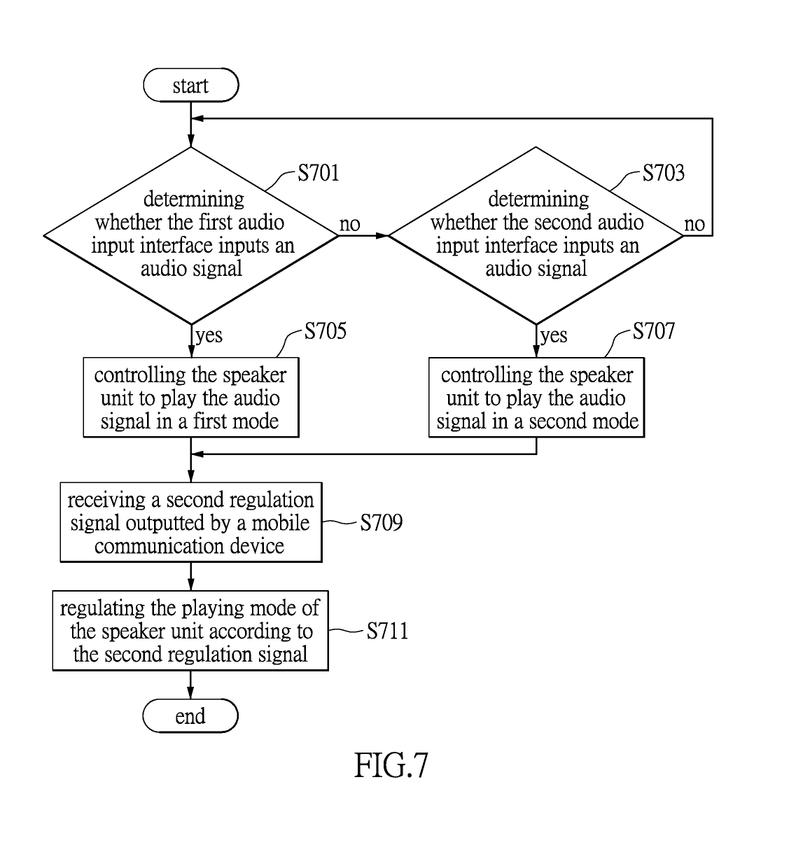

FIG. 7 shows a flow chart of the control method for controlling a headphone device according to another embodiment of FIG. 4 in the present invention. Please refer to FIG. 7 and FIG. 4. The control method for controlling a headphone device 1b of the present embodiment is similar to that for controlling a headphone device 1 of the previous embodiment. However, the difference of the control methods for controlling the headphone devices 1b, 1 consists in that in the present embodiment, the headphone device 1b is controlled by a mobile communication device 8, so as to control the sound volume and sound range outputted by the speaker unit 14b.

After step S705 or S707, step S709 is performed. In order to describe conveniently, in the present embodiment the step S705 is illustrated by “controlling the speaker unit 14b to play the audio signal in a first mode”.

In step S709, a second regulation signal outputted by the mobile communication device 8 is received. In practice, the second regulation signal is different from the first regulation signal. For example, the first regulation signal is a signal generated when the host 9 recognizes a position signal, while the second regulation signal is a signal generated when the user operates the mobile communication device 8, thereby the user can actively regulate the sound range and sound volume by means of the mobile communication device 8 when the speaker unit 14a outputs sound. The flow chart of operation is similar to the content of the previous embodiment and will not be described here.

In step S711, the playing mode of the speaker unit 14b is regulated according to the second regulation signal. In practice, when a second user operates an electronic game, other users or the second user can personally output a second regulation signal to the headphone device 1b via the mobile communication device 8, thus the playing mode of the speaker unit 14b is regulated. For example, the sound range and the sound volume outputted by the speaker unit 14b are regulated. In addition to the above difference, those skilled in the art should easily infer other differences by referring to the above embodiments and difference, therefore the description thereof is omitted here.

It is worth mentioning that the steps S709 and S711 in FIG. 7 can be incorporated into FIG. 6 to be located after the step S615; or the steps S609, S611, S613 and S615 in FIG. 6 can be incorporated into FIG. 7 to be located after the step S711, thereby the headphone device 1b receives the first or the second regulation signal, so as to regulate the playing mode of the speaker unit 14b. The type of incorporating some steps of FIG. 7 into FIG. 6 or incorporating some steps of FIG. 6 into FIG. 7 is not limited in the present embodiment.

Summing up the above, the present invention is a headphone device. The headphone device determines whether a first or a second audio input interface receives an audio signal by means of a control unit, so as to control a speaker unit to play the audio signal in a first mode or in a second mode, wherein the first mode is a game mode and the second mode is a music mode. Thus, the operation convenience of the headphone device is enhanced. In addition, a regulation portion can output a resistance value to serve as a position signal according to the distance between an earmuffs portion and a hang-arm, such that the control unit outputs the position signal to a host via a wireless communication unit, and the host recognizes the position signal and outputs a first regulation signal to the headphone device, so as to control the sound range or sound volume outputted by the speaker unit. Furthermore, the mobile communication device may output a second regulation signal too, and the headphone device regulates the playing mode of the speaker unit according to the second regulation signal. In this manner, the operation convenience of the headphone device in the present invention is enhanced.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A headphone device, comprising:
a first audio input interface;
a second audio input interface;
a speaker unit; and
a control unit, coupled to the first audio input interface, the second audio input interface and the speaker unit, wherein the control unit determines whether an audio signal is inputted by the first audio input interface or the second audio input interface, and then controls the playing mode of the speaker unit to play the audio signal in a first mode or in a second mode based on decision result.

2. The headphone device according to claim 1, wherein when the control unit determines that the first audio input interface has received the audio signal, the speaker unit is controlled to play the audio signal in a first mode, and when the control unit determines that the second audio input interface has received the audio signal, the speaker unit is controlled to play the audio signal in a second mode.

3. The headphone device according to claim 2, wherein the first mode is a game mode and the second mode is a music mode.

4. The headphone device according to claim 2, wherein the first audio input interface is an insertion slot coincident with a universal serial transmission protocol, while the second audio input interface is an audio jack.

5. The headphone device according to claim 2, further comprising:
a hang-arm;
an earmuffs portion, in which the speaker unit is accommodated; and
a regulation portion, pivoted between the hang-arm and the earmuffs portion, and the regulation portion being used to regulate the distance between the hang-arm and the earmuffs portion and output a position signal, generated when a user wears the headphone device, to the control unit.

6. The headphone device according to claim 5, wherein the regulation portion has a variable resistance unit, and outputs relatively a resistance value to serve as a position signal according to the distance between the earmuffs portions and the hang-arm.

7. The headphone device according to claim 5, further comprising:
a wireless communication unit, coupled to the control unit;
wherein the control unit outputs via the wireless communication unit the position signal to a host, such that an application program of the host recognizes the position signal and outputs relatively a first regulation signal to the headphone device.

8. The headphone device according to claim 7, wherein when the control unit receives the first regulation signal via the wireless communication unit, the playing mode of the speaker unit is regulated according to the first regulation signal.

9. The headphone device according to claim 8, wherein the first regulation signal is used to regulate the sound range regulation parameter and/or sound volume regulation parameter when the speaker unit outputs sound.

10. The headphone device according to claim 7, wherein the control unit receives via the wireless communication unit a second regulation signal outputted by a mobile communication device, and regulates the playing mode of the speaker unit according to the second regulation signal.

11. The headphone device according to claim 10, wherein the second regulation signal is used to regulate the sound range regulation parameter and/or sound volume regulation parameter when the speaker unit outputs sound.

12. The headphone device according to claim 6, further comprising:
a setting interface, coupled to the control unit and generating a setting signal to the control unit, such that the control unit can control the variable resistance unit to record the position signal according to the setting signal; and
a playing interface, coupled to the control unit and generating a playing instruction according to a user's operation, such that the control unit can control the playing mode of the speaker unit according to the playing instruction.

13. A control method of a headphone device, the headphone device comprising a first audio input interface, a second audio input interface, a speaker unit and a control unit, the control method comprising:
determining whether an audio signal is inputted by the first audio input interface or the second audio input interface; and
controlling the playing mode of the speaker unit to play the audio signal in a first mode or in a second mode based on decision result.

14. The control method according to claim 13, wherein when the first audio input interface is determined to have received the audio signal, the speaker unit is controlled to play the audio signal in the first mode, and when the second audio input interface is determined to have received the audio signal, the speaker unit is controlled to play the audio signal in the second mode.

15. The control method according to claim 14, wherein the first mode is a game mode and the second mode is a music mode.

16. The control method according to claim 14, further comprising:
recording a position signal generated when a user wears the headphone device.

17. The control method according to claim 16, wherein a setting signal is received before recording the position signal generated when a user wears the headphone device.

18. The control method according to claim 16, further comprising:
outputting the position signal to a host, such that an application program of the host recognizes the position signal and outputs relatively a first regulation signal to the headphone device.

19. The control method according to claim 18, further comprising:
receiving the first regulation signal, and regulating the playing mode of the speaker unit according to the first regulation signal.

20. The control method according to claim 14, further comprising:
receiving a second regulation signal outputted by a mobile communication device, and regulating the playing mode of the speaker unit according to the second regulation signal.
